(19) United States
(12) Patent Application Publication
(10) Pub. No.: US 2021/0214971 A1
(43) Pub. Date: Jul. 15, 2021

(54) LOCK PLUG WITH ELECTRIC MOTOR

(71) Applicant: WANJIA GROUP CO., LTD., Jinhua (CN)

(72) Inventor: Xinmin Cheng, Jinhua (CN)

(73) Assignee: WANJIA GROUP CO., LTD.

(21) Appl. No.: 17/211,856

(22) Filed: Mar. 25, 2021

(30) Foreign Application Priority Data
Mar. 27, 2020 (CN) 202020428519.0

(51) Int. Cl. E05B 47/00; H02K 7/00

(52) U.S. Cl. CPC E05B 47/0012; H02K 7/003

(57) ABSTRACT

Disclosed is a lock plug with an electric motor. The electric motor is mounted at an end of the lock plug body, the lock plug body includes a lock plug core, a surface of an electric motor reducer is provided with an electric motor conductive contact sleeve, a position, corresponding to an electric motor output shaft, of the centre of the lock plug core is provided with a semicircular hole groove consistent with the electric motor output shaft in shape and size, the lock plug core is provided with a set screw hole, a position, corresponding to the set screw hole, of the electric motor output shaft is provided with a set screw groove, and an overall dimension of the electric motor is smaller than that of a lock plug hole groove of a door.

### FIELD

The present utility model relates to the technical field of automatic locks, in particular to a lock plug with an electric motor.

### BACKGROUND

A lock, plug insertion hole of a security door at present is, generally about 25 mm, and an insertion slot of a lower portion of a lock plug is generally about 15 mm. However, for an electric motor of a common automatic unlocking lock plug with a split electric motor, for example, Chinese utility model application No. 2019200945574, the electric motor is additionally arranged outside the lock plug and connected to a protruding lock plug core, and consequently, the electric motor lock plug cannot be inserted into a door for being mounted in the case of the hole of this size.

A current treatment method is to enlarge the lock plug insertion hole and the insertion slot of a door panel so as to enable the electric motor lock plug to enter the lock plug hole. However, such operation modes require secondary processing on the door, thereby increasing the mounting difficulty of the electric motor lock plug.

### SUMMARY

A technical solution of the present utility model provides a lock plug with an electric motor. The lock plug with the electric motor may be mounted without extra operation on a door panel. The technical solution is as follows:

The present utility model provides the lock plug with the electric motor. The lock plug includes a lock plug body and the electric motor, wherein the electric motor is mounted at an end of the lock plug body, the lock plug body includes a lock plug core and a lock plug case, the electric motor is fixedly connected to the lock plug core, and an electric motor conductive contact sleeve insulated from the electric motor is arranged on a surface of an electric motor reducer; a position, corresponding to an electric motor output shaft, of the centre of the lock plug core is provided with a semicircular hole groove consistent with the electric motor output shaft ins shape and size, the lock plug core is provided with a set screw hole, and a position, corresponding to the set screw hole, of the electric motor output shaft is provided with a set screw groove; and the electric motor and an electric motor sleeve are positioned through a jump ring, and an overall dimension of the electric motor is smaller than that of a lock plug hole groove of a door.

Through mounting of the electric motor at the end of the lock plug, when an overall dimension of a used electric motor is smaller than that of the lock, plug hole groove of the door, reaming operation on the door may be avoided. Instead, the lock plug and the electric motor connected to the lock plug may be directly inserted into a preset door hole, and are inserted, through the preset door hole, into a lock body lock plug hole for fixation, thus finally avoiding secondary processing on the door panel and realizing mounting of the lock plug with the electric motor.

The electric motor lock plug further includes an electric motor fixation part. One end of the electric motor fixation part is provided with an electric motor insertion hole groove which is consistent with the electric motor in, shape, and the other end is provided with two mounting holes which are fixedly connected to a bottom of the lock plug case. The bottom of the lock plug case is provided with a screw fixation hole which is consistent with the mounting hole of the electric motor fixation part. An overall dimension of the electric motor and the electric motor fixation part is smaller than that, of the lock plug hole groove of the door.

The electric motor is fixedly connected to the lock plug through the electric motor fixation part, so as to guarantee the stability of the lock plug with the electric motor. It is certain that this lock plug is merely applied to the single automatic electric motor lock, plug with double-fast-function lock body.

Particularly, the lock plug with the electric motor further includes the electric motor sleeve and a cover plate sleeve frame. At least one limitation bulge is arranged outside the electric motor sleeve, a hole groove corresponding to an electric motor housing in shape is arranged inside the electric motor sleeve, an insertion hole adapting to the periphery of the electric motor sleeve is arranged on the cover plate sleeve frame, and a limitation groove corresponding to the limitation bulge is arranged on the cover plate sleeve frame.

The electric motor sleeve is internally provided with a hole groove corresponding to the electric motor housing, and an electric motor with an elliptical-similarly electric motor housing is used, such that a position of the electric motor in the sleeve may be relatively fixed. In addition, a sleeve rack groove and a sleeve bulge are arranged, such that when the electric motor sleeve limitation bulge is inserted into the cover plate sleeve frame limitation groove, the electric motor sleeve and the cover plate sleeve frame may be relatively fixed in position, and an electric motor frame may be relatively fixed as well, thereby avoiding relative rotation of the electric motor frame when the electric motor rotates during automatic unlocking or locking, and causing the electric motor to more stably drive the lock plug core to rotate.

Particularly, a spring is arranged between the interior of the electric motor sleeve and the electric motor housing.

Through arrangement of the spring in the electric motor sleeve, under normal circumstances, the electric motor sleeve limitation bulge is caused to be inserted into the cover plate sleeve frame limitation groove through tension of the spring in the electric motor sleeve, such that the electric motor housing may not rotate, and automatic unlocking or locking may be realized by controlling the electric motor to rotate. When the electric motor may not achieve unlocking, the groove and bulge may be relatively staggered by pressing the electric motor sleeve, thus destroying relative fixation between the electric motor sleeve and the cover plate sleeve frame. At this time, the whole electric motor may be rotated by manually rotating the electric motor sleeve to realize indoor manual unlocking.

Particularly, the electric motor conductive contact sleeve includes an inner layer insulation sleeve and an outer layer conductive layer. The inner layer insulation sleeve covers the surface of the electric motor reducer, the outer layer conductive layer is sleeved on the inner layer insulation sleeve, the outer layer conductive layer is electrically connected to one power supply connection point of the electric motor, the other power supply connection point of the electric, motor is electrically connected to the electric motor housing, and a power supply elastic sheet is arranged at one side, close to the outer layer conductive layer, of the lock plug case, the power supply elastic sheet being in elastic contact with outer layer conductive layer.

Through arrangement of the power supply connection point electrically connecting the power supply elastic sheet and the electric motor housing, power supply of the electric motor may be directly or indirectly connected to the power supply elastic sheet and the electric motor housing, these two portions are in a relatively static state during whole unlocking action, thus avoiding the phenomenon that a power supply circuit is required to be driven to simultaneously rotate when the whole electric motor is rotated for manual unlocking, avoiding winding and twisting of the circuit, and improving operation stability of the lock plug with the electric motor.

### BRIEF DESCRIPTION OF THE DRAWINGS

The accompanying drawings herein are incorporated into the specification as integral part of the specification, show embodiments conforming to the present utility model, and are used, together with the specification, to explain principles of the present utility model. Among the drawings:

FIG. 1 is a schematic diagram of a solid structure of a lock plug with an electric motor;

FIG. 2 is schematic diagrams of solid structures of the electric motor, a sleeve, and the lock plug;

FIG. 3 is a sectional view of FIG. 2 with the sleeve removed; and

FIG. 4 is a single automatic electric motor lock plug with a double-fast-function lock body.

Reference numerals: 1 Electric motor, 2 Lock plug, 3 Lock plug core, 4 Lock plug case, 5 Electric motor conductive contact sleeve, 6 Electric motor output shaft and lock plug semicircular hole groove, 7 Lock plug set screw hole, 8 Electric motor output shaft set screw groove, 9 Electric motor sleeve, 10 Cover plate sleeve frame, 11 Sleeve limitation bulge, 12 Sleeve rack limitation groove, 13 Inner layer insulation sleeve, 14 Outer layer conductive layer, 15 Power supply elastic sheet, 16 Lock plug semicircular hole groove, 17 Fixation part, and 18 Mounting hole.

### DETAILED DESCRIPTION OF THE EMBODIMENTS

The following disclosure provides many different embodiments or examples for realizing different structures of the present utility model. In order to simplify the disclosure of the present utility model, parts and settings of specific examples are described below. Apparently, they are merely examples, and are not intended to limit the present utility model. In addition, the present utility model may repeat reference numerals and/or reference letters in different examples. This repetition is for the purpose of simplification and clarity, and itself does not indicate a relationship between various embodiments and/or settings discussed. In addition, the present utility model provides examples of various specific processes and materials, but a person of ordinary skill in the art may conceive applications of other processes and/or use of other materials.

A lock plug insertion hole of a security door at present is generally about 25 mm, and an insertion slot of a lower portion of a lock plug is generally about 15 mm. However, for an electric motor of a common automatic unlocking lock plug with a split electric motor, for example, Chinese utility model application No. 2019200945574, the electric motor is additionally arranged outside the lock, plug and connected to a protruding lock plug core, and consequently, the electric motor lock plug cannot be inserted into a door for being mounted in the ease of the hole of this size.

A current treatment method is to enlarge the lock plug insertion hole and the insertion slot of a door panel so as to enable the electric motor lock plug to enter the lock plug hole. However, such operation modes require secondary processing on the door, thereby increasing the mounting difficulty of the electric motor lock plug.

A technical solution of the present utility model provides a lock plug with an electric motor. The lock plug with the electric motor may be mounted without extra operation on the door panel. The technical solution is described below.

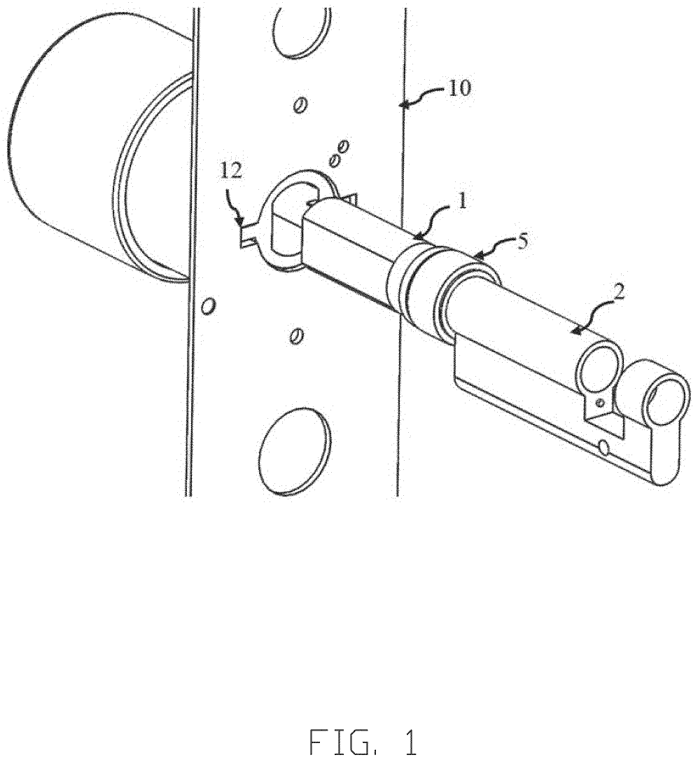

The present utility model will be further described below in detail according to FIG. 1 to FIG. 4.

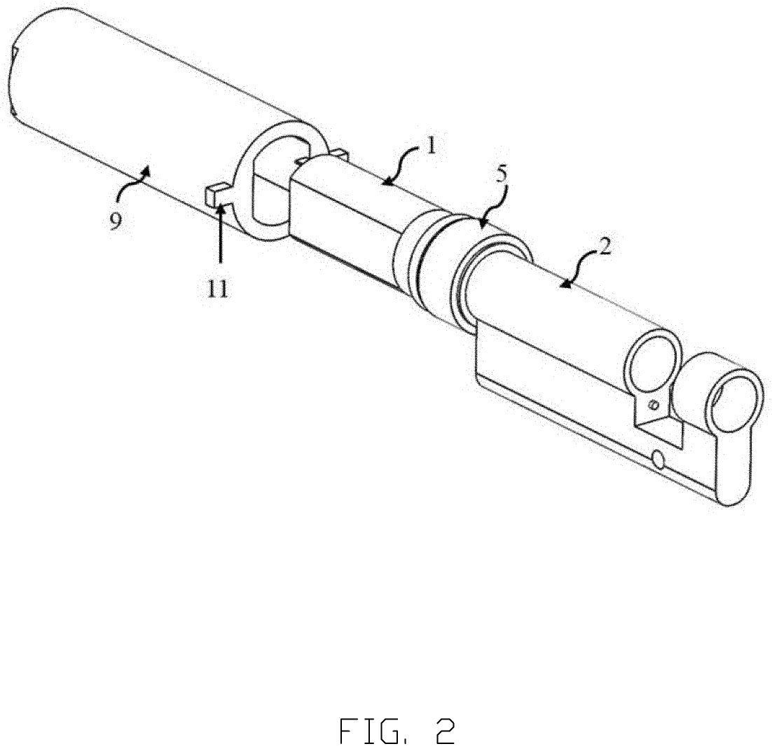

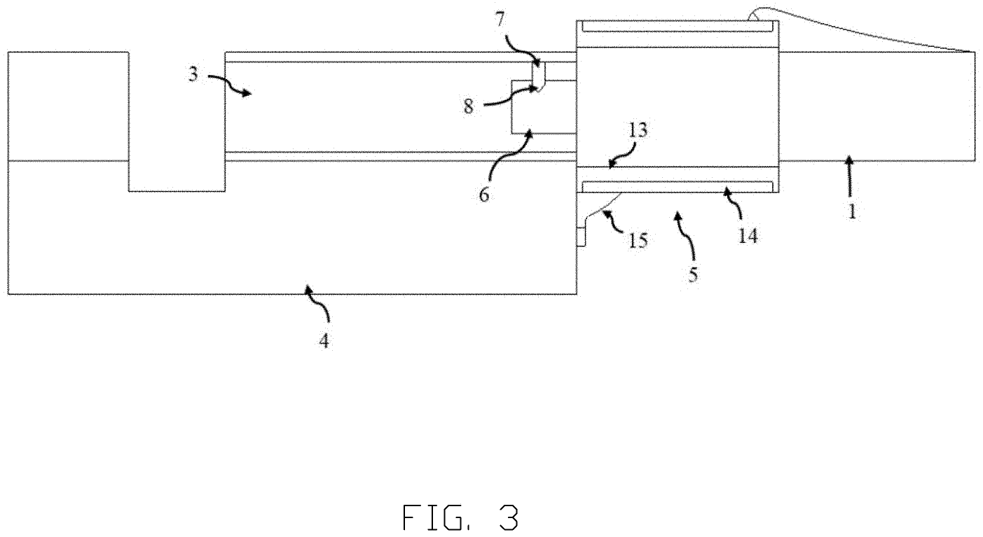

As shown in FIG. 1, FIG. 2 and FIG. 3, the present utility model provides the lock plug with the electric motor. The lock plug includes a lock plug body and the electric motor. The electric motor is mounted at an end of the lock plug body, the lock plug body includes a lock plug core and a lock plug case, the electric motor is fixedly connected to the lock plug core, and an electric motor conductive contact sleeve insulated from the electric motor is arranged on a surface of an electric motor reducer. A position, corresponding to an electric motor output shaft, of the centre of the lock plug core is provided with a semicircular hole groove consistent with the electric motor output shaft in shape and size, the lock plug core is provided with a set screw hole, and a position, corresponding to the set screw hole, of the electric motor output shaft is provided with a set screw groove. The electric motor and an electric motor sleeve are positioned through a jump ring, and an overall dimension of the electric motor is smaller than that of a lock plug hole groove of a door.

Through mounting of the electric motor at the end of the lock plug, when an overall dimension of a used electric motor is smaller than that of the lock plug hole groove of the door, reaming operation on the door may be avoided. Instead, the lock plug and the electric motor connected to the lock plug may be directly inserted into a preset door hole, and are inserted, through the preset door hole, into a lock body lock plug hole for fixation, thus finally avoiding secondary processing on the door panel and realizing mounting of the lock plug with the electric motor.

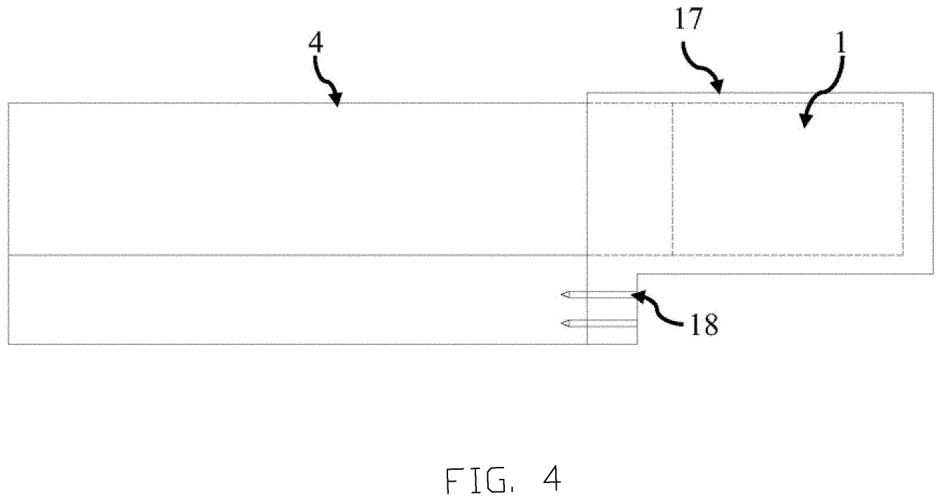

As shown in FIG. 4, the electric motor lock plug further includes an electric motor fixation part. One end of the electric motor fixation part is provided with an electric motor insertion hole groove which is consistent with the electric motor in shape, and the other end is provided with two mounting holes which are fixedly connected to a bottom of the lock plug case. The bottom of the lock plug case is provided with a screw fixation hole which is consistent with the mounting hole of the electric motor fixation part. An overall dimension of the electric motor and the electric motor fixation part is smaller than that of the lock plug hole groove of the door.

The electric motor is fixedly connected to the lock plug through the electric motor fixation part, so as to guarantee the stability of the lock plug with the electric motor. It is certain that this lock plug is merely applied to the single automatic electric motor lock plug with double-fast-function lock body.

Particularly, the lock plug with the electric motor further includes the electric motor sleeve and a cover plate sleeve frame. At least one limitation bulge is arranged outside the electric motor sleeve, a hole groove corresponding to an electric motor housing in shape is arranged inside the electric motor sleeve, an insertion hole adapting to the periphery of the electric motor sleeve is arranged on the cover plate sleeve frame, and a limitation groove corresponding to the limitation bulge is arranged on the cover plate sleeve frame.

The electric motor sleeve is internally provided with a hole groove corresponding to the electric motor housing, and an electric motor with an elliptical-similarly electric motor housing is used, such that a position of the electric motor in the sleeve may be relatively fixed. In addition, a sleeve rack groove and a sleeve bulge are arranged, such that when the electric motor sleeve limitation bulge is inserted into the cover plate sleeve frame limitation groove, the electric motor sleeve and the cover plate sleeve frame may be relatively fixed in position, and an electric motor frame may be relatively fixed as well, thereby avoiding relative rotation of the electric motor frame when the electric motor rotates during automatic unlocking or locking, and causing the electric motor to more stably drive the lock plug core to rotate.

Particularly, a spring is arranged between the interior of the electric motor sleeve and the electric motor housing.

Through arrangement of the spring in the electric motor sleeve, under normal circumstances, the electric motor sleeve limitation bulge is caused to be inserted into the cover plate sleeve frame limitation groove through tension of the spring in the electric motor sleeve, such that the electric motor housing may not rotate, and automatic unlocking or locking may be realized by controlling the electric motor to rotate. When the electric motor may not achieve unlocking, the groove and bulge may be relatively staggered by pressing the electric motor sleeve, thus destroying relative fixation between the electric motor sleeve and the cover plate sleeve frame. At this time, the whole electric motor may be rotated by manually rotating the electric motor sleeve to realize indoor manual unlocking.

Particularly, the electric motor conductive contact sleeve includes an inner layer insulation sleeve and an outer layer conductive layer. The inner layer insulation sleeve covers the surface of the electric motor reducer, the outer layer conductive layer is sleeved on the inner layer insulation sleeve, the outer layer conductive layer is electrically connected to one power supply connection point of the electric motor, the other power supply connection point of the electric motor is electrically connected to the electric motor housing, and a power supply elastic sheet is arranged at one side, close to the outer layer conductive layer, of the lock plug case, the power supply elastic sheet being in elastic contact with outer layer conductive layer.

Through arrangement of the power supply connection point electrically connecting the power supply elastic sheet and the electric motor housing, power supply of the electric motor may be directly or indirectly connected to the power supply elastic sheet and the electric motor housing, these two portions are in a relatively static state during whole unlocking action, thus avoiding the phenomenon that a power supply circuit is required to be driven to simultaneously rotate when the whole electric motor is rotated for manual unlocking, avoiding winding and twisting of the circuit, and improving operation stability of the lock plug with the electric motor.

Particularly, the electric motor housing is electrically connected to the electric motor output shaft through an internally connected mechanical gear, the electric motor output shaft and the lock plug core are electrically interconnected as well, the lock plug core and lock plug case are further electrically interconnected, such that one power supply connection point connected to the electric motor housing is caused to be electrically interconnected through the mechanical gear, the electric motor output shaft, the lock plug core and the lock plug case. Consequently, as long as the lock plug case is connected, one connection point of the electric motor may be electrified, and the other connection point may be used for directly electrifying the elastic sheet.

What is claimed is:

1. A lock plug with an electric motor, the lock plug comprising a lock plug body and the electric motor, wherein the electric motor is mounted at an end of the lock plug body, the lock plug body comprises a lock plug core and a lock plug case, the electric motor is fixedly connected to the lock plug core, and an electric motor conductive contact sleeve insulated from the electric motor is arranged on a surface of an electric motor reducer; the centre, corresponding to an electric motor output shaft, of the lock plug core is provided with a semicircular hole groove with the same shape and size as those of the electric motor output, shaft, the lock plug core is provided with a set screw hole, and a position, corresponding to the set screw hole, of the electric motor output shaft is provided with a set screw groove; and the electric motor and an electric motor sleeve are positioned through a jump ring, and an overall dimension of the electric motor is smaller than that of a lock plug hole groove of a door.

2. The lock plug with the electric motor according to claim 1, wherein the lock plug with the electric motor further comprises an electric motor fixation part, wherein one end of the electric motor fixation part is provided with an electric motor insertion hole groove which is consistent with the electric motor in shape, and the other end is provided with two mounting holes which are fixedly connected to a bottom of the lock plug case; the bottom of the lock plug case is provided with a screw fixation hole which is consistent with the mounting hole of the electric motor fixation part; and an overall dimension of the electric motor and the electric motor fixation part is smaller than that of the lock plug hole groove of the door.

3. The lock plug with the electric motor according to claim 1, wherein the lock plug with the electric motor further comprises the electric motor sleeve and a cover plate sleeve frame, wherein at least one limitation bulge is arranged outside the electric motor sleeve, a hole groove corresponding to an electric motor housing in shape is arranged inside the electric motor sleeve, an insertion hole adapting to the periphery of the electric motor sleeve is arranged on the cover plate sleeve frame, and a limitation groove corresponding to the limitation bulge is arranged on the cover plate sleeve frame.

4. The lock plug with the electric motor according to claim 3, wherein a spring is arranged between the interior of the electric motor sleeve and the electric motor.

5. The lock plug with the electric motor according to claim 3, wherein the electric motor conductive contact sleeve comprises an inner layer insulation sleeve and an outer layer conductive layer, wherein the inner layer insulation sleeve covers the surface of the electric motor reducer, the outer layer conductive layer is sleeved on the inner layer insulation sleeve, the outer layer conductive layer is electrically connected to one power supply connection point of the electric motor, the other power supply connection point of the electric motor is, electrically connected to the electric motor housing, and a power supply elastic sheet is arranged at one side, close to the outer layer conductive layer, of a bottom of the lock plug body, the power supply elastic sheet being in elastic contact with outer layer conductive layer.
